(19) United States
(12) Patent Application Publication
(10) Pub. No.: US 2011/0000420 A1
(43) Pub. Date: Jan. 6, 2011

(54) Bookmarker of flexible material designed to pinpoint the readers last spot in a book

(76) Inventor: Erik Anthony Vaught, Azusia, CA (US)

Correspondence Address: Erik Anthony Vaught, 167 N Sun Gabriel Ave., Azusa, CA, 91702, US

(21) Appl. No.: 12/459,599

(22) Filed: Jul. 6, 2009

(51) Int. Cl. B42D 9/00

(52) U.S. Cl. 116/235

(57) ABSTRACT

One Embodiment of a Bookmarker thin, flat long rigid yet bendable, and durable material FIG. 1A). This Embodiment having a means for clipping to a page (#2), and a pointing device that is attached yet movable in a vertical direction (#5).

### FEDERALLY SPONSORED RESEARCH

Not Applicable

### SEQUENCE LISTING OR PROGRAM

Not Applicable

### BACKGROUND OF THE INVENTION

### Field of Invention

This invention relates to such bookmarkers designed to mark the spot where a person last read easy to get to when needed.

### Prior Art

Bookstores to my knowledge, offer only one bookmarker that is design to attempt to tell a person where they left off.

This product is call book darts. Book darts are small and easy to loose that is why they give 50 in a pack. The darts cannot tell a person exactly where they left off; they only mark the edge of the page.

Other bookmarkers that are patented will tell a person where they left off. However, there are many problems with them. For example, these bookmarkers are either too expensive to make, take too long to set up in the book, not durable, too clumsy and too big.

### Objects And Advantages

(a) Provide an inexpensive design for production.

(b) Make a bookmarker that can be set up in very little time.

(c) Make a bookmarker that will last for years with little chance of breaking.

(d) Make a bookmarker that is very easy to use, and not too bulky.

### SUMMARY

In accordance with the present invention, a bookmarker comprises a main body, clip on part in the main body and a sliding arrow.

### DRAWINGS—FIGURES

The drawings present two different figures, 1A, 1B.

FIG. 1A shows how the invention will be manufacture.

FIG. 1B shows how the bookmark will be ensemble.

### DRAWINGS—Reference Numerals

2 clip on cut
3 main body
4A cut
4B cut
5 arrow
6A cut
6B cut
7 breakaway cut
8 breakaway cut
9 hole
10A angled cut
10B angled cut

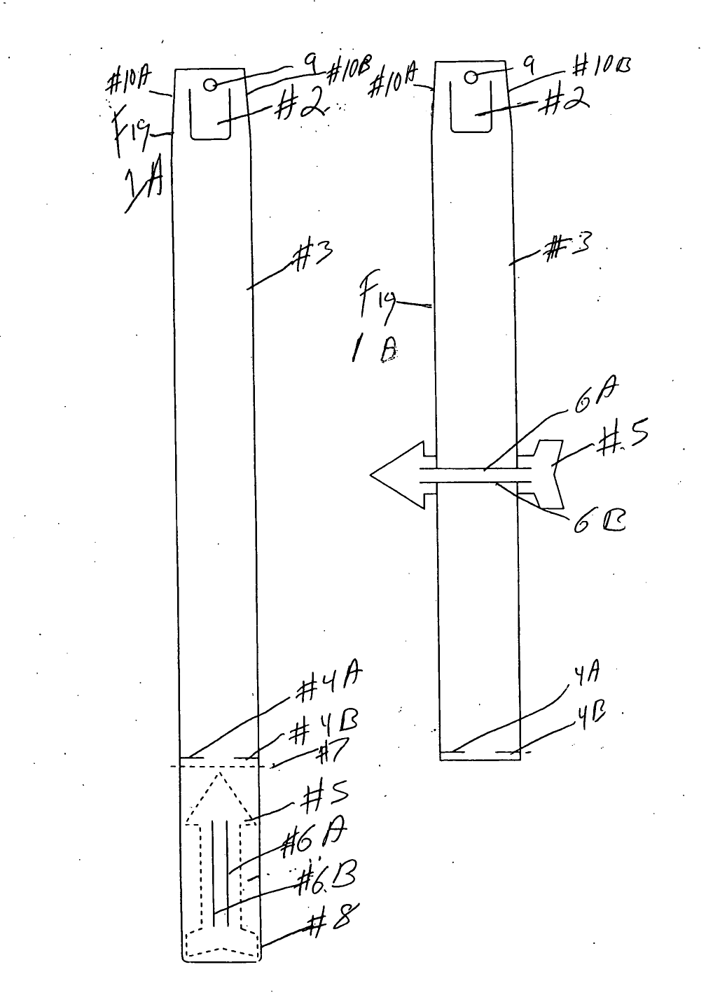

### DETAILED DESCRIPTION—FIGS. 1A AND 1B—PREFERRED EMBODIMENT

A preferred embodiment unassembled FIG. 1A, (side view) main body #3 is made of rigid and flexible material to allow #2 (the clip on cut) to clip to the page and attach to the average book page without slipping. The numbers 4A and 4B are cuts to allow the button of the bookmark when assemble to be bent so that #5 the arrow will not slip off. The #7 is a break away line to detach the arrow and the material around the arrow that is meant to be discarded.

The cuts, 6A and 6B, are exactly as wide Patent Application of Erik A. Vaught for “Pin Point Bookmarker” [symbol] e as the main body #3.

FIG. 1B is the assembled bookmarker with the arrow, #5, attached with the main body and #3 threaded in to the cuts, 6A and 6B, in the arrow. #5.

The diagonal cuts #10A and 10B are in place to help thread the arrow #5 to the main body #3.

### Operation—FIGS. 1A, 1B

The first thing to do when the unassembled bookmarker FIG. 1A is in a person's hand is to bend and brake along the breakaway line #7. The next step is to breakaway the arrow #5 from the material around it, and discards the unwanted material. The way this is done with the use of the breakaway cuts around the arrow #8.

The arrow #5 then is meant to be thread in to the main body #3 from the top of the main body with the use of the diagonal cuts #10A and 10B, to make it easy.

The fit is meant to be very tight so that the arrow will not slide up or down on its own. The material below the cuts #4A and 4B are meant to be bent towards the lower end of the arrow so that the arrow will not easily come off the main body.

FIG. 1B, is the finished product without bends on the lower ends. The way this works is first to clip the bookmarker to the left or right page where a person left off, and to slide the arrow up or down to the sentence where a person left off. If the book has two columns, the arrow can be flip to the left or right depending on which column a person left off reading.

This device is meant to save time when reading, so that one does not read over what they have reed. This bookmarker is especially good for students who have from two to six books at once. If the save twenty seconds on each book each day they can save a lot of time each year towards their studies.

| | | |
|---|---|---|
| 6,641,172 | Olson | Jan. 07, 2002 |
| 5,992,887 | Maruchi | Feb. 10, 1997 |
| 5,439,254 | Dorion | Sep. 02, 1992 |
| 4,932,351 | Capamaggio | Oct. 11, 1988 |
| 4,928,621 | Capamaggio | Dec. 31, 1988 |

1. A thin, flat, narrow structure with means to clip on to a flat thin surface at top of structure, and a smaller pointed device flat that can be attached to set flat narrow structure movable on a vertical direction.
